(19) United States
(12) Patent Application Publication
(10) Pub. No.: US 2003/0071914 A1
(43) Pub. Date: Apr. 17, 2003

(54) Image-capturing system capable of changing an image capturing angle

(76) Inventors: Erh-Chang Wei, Taipei City (TW); Jong-Ding Wang, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/064,048

(22) Filed: Jun. 4, 2002

(30) Foreign Application Priority Data
Oct. 11, 2001 (TW) 090125139

(51) Int. Cl. H04N 5/225; H04N 5/232

(52) U.S. Cl. 348/375; 348/376; 348/211.2

(57) ABSTRACT

An image-capturing system includes an image-capturing module and a remote control. The image-capturing module has a digital camera for capturing images and a driving device for adjusting an image capturing angle of the digital camera. The remote control has a display panel for displaying images captured by the digital camera and a control panel for controlling the driving device. A user can utilize the control panel to control the driving device so as to change the image capturing angle of the digital camera, and can preview an image captured by the digital camera using the display panel of the remote control.

### BACKGROUND OF INVENTION

1. Field of the Invention

The present invention relates to an image-capturing system. More specifically, the present invention discloses an image-capturing device for adjusting an image capturing angle of a digital camera by using a remote control.

2. Description of the Prior Art

In the camera field, some cameras have remote functionality. Such a camera commonly has a remote control for controlling the camera. A user can operate the camera from a distance using the remote control, and can execute function such as switching the camera shutter on or off.

However, such cameras are not without problems. For example, when a user wishes to capture an image using the remote control, the user must guess at the angle and the zoom factor in an attempt to move the camera into the desired position. This guessing process is very inconvenient and inaccurate, and the user cannot preview the image in the display panel to help in adjusting the angle and zoom factor of the camera.

### SUMMARY OF THE INVENTION

It is therefore a primary objective of the present invention to provide an image-capturing system capable of adjusting an image-capturing angle of a digital camera.

The present invention discloses an image-capturing system. The image-capturing system comprises an image-capturing module and a remote control. The image-capturing module has a digital camera for capturing images and a driving device for adjusting an image capturing angle of the digital camera. The remote control has a display panel for displaying images captured by the digital camera and a control panel for controlling the driving device. A user can utilize the control panel to control the driving device so as to change the image capturing angle of the digital camera. The user can preview an image captured by the digital camera using the display panel of the remote control.

It is an advantage of the present invention that the image-capturing system 10 utilizes a driving device 20 to adjust the image capturing angle of the digital camera 16. When a user uses the remote control 14 to capture images, the user can preview the image that will be captured by the digital camera 16 through the display panel 22. The user can then utilize the angle-adjusting key 30 to adjust the image capturing angle of the digital camera 16.

These and other objectives and advantages of the present invention will no doubt become obvious to those of ordinary skill in the art after reading the following detailed description of the preferred embodiment that is illustrated in the various figures and drawings.

### BRIEF DESCRIPTION OF DRAWINGS

FiG. 1 is a diagram of an image-capturing system according to the present invention.

FIG. 2 is a back view of a digital camera depicted in FIG. 1.

FIG. 3 is a diagram of a driving device depicted in FIG. 1.

### DETAILED DESCRIPTION

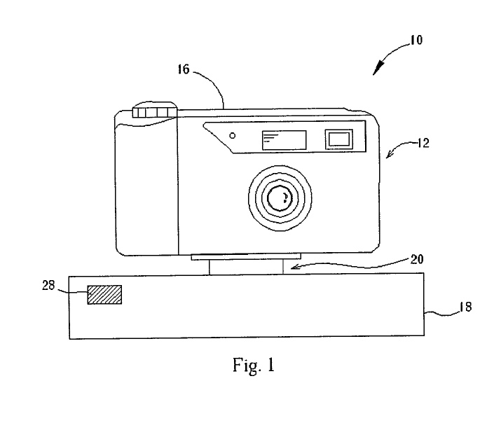

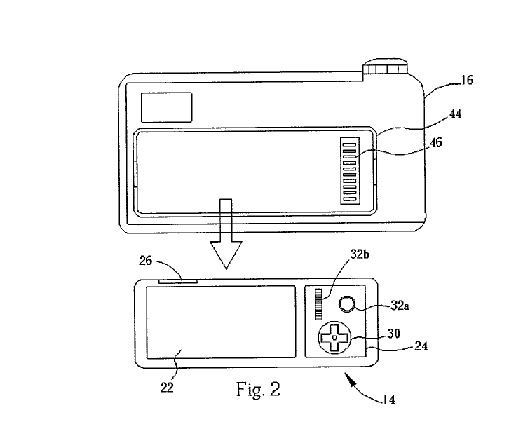

Please refer to FIG. 1 and FIG. 2. FIG. 1 is a diagram of an image-capturing system 10 according to the present invention. FIG. 2 is a back view of a digital camera 16 depicted in FIG. 1. The image-capturing system 10 comprises an image-capturing module 12 and a remote control 14. The image-capturing module 12 comprises a chassis 18, and a separate digital camera 16 separately installed on the chassis 18 for capturing images. The remote control 14 comprises a display panel 22 and a control panel 24, and is separately installed on the back of the digital camera 16. The image-capturing module 12 further comprises a driving device 20 disposed inside the chassis 18 and connected to the digital camera 16 for adjusting an image-capturing angle of the digital camera 16.

As shown in FIG. 1 and FIG. 2, the remote control 14 is separately installed on the digital camera 16. A user can separate the remote control 14 from the digital camera 16 so as to utilize the remote control 14 to control the driving device 20 and the digital camera 16. The digital camera 16 comprises a concave slot 44 for housing the remote control 14, and an electrical interface 46 for providing an electrical connection between the digital camera 16 and the remote control 14. When the remote control 14 is installed inside the concave slot 44, the user can operate the digital camera using the remote control 14. When the remote control 14 is separated from the digital camera 16, the user can remotely operate the driving device 20 and the digital camera 16.

The remote control 14 has a transceiver 26, and the image-capturing device has a corresponding transceiver 28 disposed on the chassis 18. When the remote control 14 is separated from the digital camera 16, the image-capturing module 12 and the remote control 14 transmit and receive wireless signals using their respective transceivers 26, 28 so as to transmit control commands and image data. There are many types of wireless transmission standards, including bluetooth and infrared, and all of the standards are implied in this invention. Methods using wireless transmission to transmit data are all in accordance with the spirit of this invention.

The remote control 14 further comprises a display panel 22 and a control panel 24. The display panel 22 is a liquid crystal display (LCD) panel for immediately displaying images captured by the digital camera 16. The control panel 24 comprises an angle-adjusting key 30 for controlling the driving device 20 so as to change the image-capturing angle of the digital camera 16. The control panel 24 further comprises a plurality of operating keys 32a, 32b used for opening the camera shutter, and zooming, respectively. Of course, a designer can create keys to control any function of the digital camera 16, such as adjusting aperture setting, adjusting a shutter speed, switching between automatic and manual modes, adjusting images, etc.

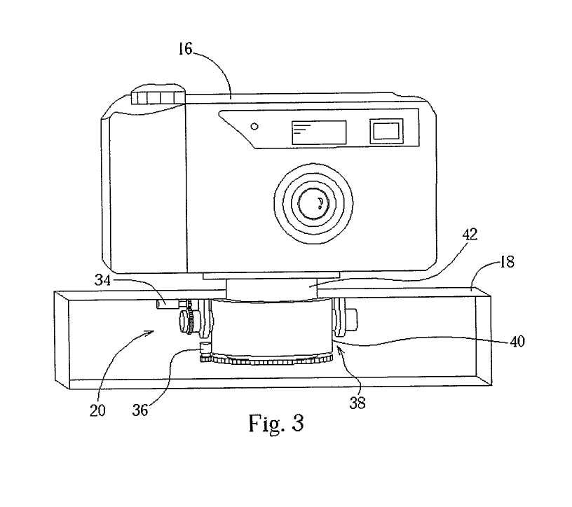

Please refer to FIG. 3. FIG. 3 is a diagram of the driving device 20 depicted in FIG. 1. As mentioned above, the driving device 20 is used to adjust the image-capturing angle of the digital camera 16. A user can utilize the angle-adjusting key 30 of the remote control 14 to control the driving device 20 so as to capture desired images. As shown in FIG. 3, the driving device 20 comprises a first stepping motor 34, a second stepping motor 36, and a two-dimensional transmission gear 38 for rotating the digital camera 16 clockwise or counterclockwise. The two-dimensional transmission gear 38 comprises an outer hollow shaft 40 rotatably disposed on the chassis 18, and an inner shaft 42 rotatably disposed inside the outer hollow shaft 40. The first stepping motor 34 is fixed on the chassis 18, and the second stepping motor 36 is fixed on the outer shaft 40. When the first stepping motor 34 rotates, the outer shaft 40 will rotate with respect to the chassis 18 so that the digital camera 16 will be tilted forwards or backwards with respect to the chassis 18 so as to change an angle of elevation of the digital camera 16. When the second stepping motor 36 rotates, the inner shaft 42 will rotate with respect to the outer shaft 40 so that the digital camera 16 will rotate with respect to the outer shaft 40 so as to change the image-capturing angle of the digital camera 16.

When a user uses the present invention image-capturing system 10, the user can install the digital camera 16 on the chassis 18 and remove the remote control 14 from the digital camera 16. Then, the user can utilize the display panel 22 of the remote control 14 to preview the images captured by the digital camera 16. The user can utilize the angle-adjusting key 30 to adjust the image-capturing angle of the digital camera 16 and the operating key 32b to zoom the display panel. When the image displayed in the display panel 22 is properly set, the user utilizes the operating key 32a to open the camera shutter so as to capture the image.

The present invention driving device 20 and the chassis 18 are not limited as above. For example, the chassis can be a tripod, and a designer can further design another kind of driving device to accomplish the objective of changing the image capturing angle of the digital camera. To lower the cost of manufacture, the designer can also design a digital camera that rotate along only one axis. All designs using a remote control to control the driving device so as to change the image-capturing angle of a digital camera are in accordance with spirit of this invention.

In contrast to the prior art, the present invention image-capturing system 10 utilizes a driving device 20 to adjust the image-capturing angle of a digital camera 16. When a user uses the remote control 14 to capture images, the user can preview the images captured by the digital camera 16 through the display panel 22, and then utilize the angle-adjusting key 30 to adjust the image-capturing angle of the digital camera 16. It is convenient that the user does not need to move toward the digital camera to adjust the image capturing angle, yet can still preview the image so as not to capture an unwanted image.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An image-capturing system comprising:
an image-capturing module comprising:
a digital camera for capturing images; and
a driving device for adjusting an image capturing angle of the digital camera; and
a remote control comprising:
a display panel for displaying images captured by the digital camera; and
a control panel for controlling the driving device;
wherein a user is capable of using the control panel to control the driving device so as to change the image capturing angle of the digital camera, and previewing an image captured by the digital camera using the display panel of the remote control.

2. The image-capturing system of claim 1 wherein the image-capturing module further comprises a chassis for positioning the digital camera, the driving device being disposed inside the chassis and connected to the digital camera, the driving device being capable of changing a position of the digital camera relative to the chassis so as to change the image capturing angle of the digital camera.

3. The image-capturing system of claim 2 wherein the digital camera is capable of being separated from the chassis.

4. The image-capturing system of claim 2 wherein the driving device comprises at least a motor and a transmission gear for rotating the digital camera with respect to the chassis.

5. The image-capturing system of claim 4 wherein the driving device comprises two motors, and the transmission gear is a two-dimensional transmission gear for rotating the digital camera clockwise or counterclockwise.

6. The image-capturing system of claim 1 wherein the remote control is capable of being installed on the digital camera.

7. The image-capturing system of claim 1 wherein the image-capturing module further comprises a transceiver, the remote control further comprising a transceiver, the image-capturing module and the remote control transmit and receive wireless signals using the respective transceivers.

8. The image-capturing system of claim 7 wherein the image-capturing module and the remote control transmit and receive wireless signals using bluetooth protocol.

9. The image-capturing system of claim 7 wherein the image-capturing module and the remote control transmit and receive wireless signals using infrared light.

10. The image-capturing system of claim 1 wherein the display panel is a liquid crystal display (LCD) panel.
